(19) United States
(12) Patent Application Publication
(10) Pub. No.: US 2024/0352729 A1
(43) Pub. Date: Oct. 24, 2024

(54) SYSTEMS AND METHODS FOR INTEGRATING FIRE SAFETY FEATURES WITHIN ROBOTIC FURNITURE AND INTERIOR ARCHITECTURAL ELEMENTS

(71) Applicant: Ori Inc., Boston, MA (US)

(72) Inventors: Ivan Fernandez de Casadevante, Somerville, MA (US); Hasier Larrea Tamayo, Brooklyn, NY (US); Nathanael Roberts, Brooklyn, NY (US); Reed Finlay, Ojai, CA (US); Robert T. Hsiung, Cambridge, MA (US); Carlos Rubio, Austin, TX (US); Kevin Guo, Naples, FL (US); Jack Murphy, Belmont, MA (US); Toby White, Medford, MA (US)

(21) Appl. No.: 18/686,737

(22) PCT Filed: Aug. 25, 2022
(86) PCT No.: PCT/US2022/041564

§ 371 Date: Feb. 26, 2024

Related U.S. Application Data
(60) Provisional application No. 63/237,362, filed on Aug. 26, 2021.

(51) Int. Cl. E04B 1/94; A47C 17/38; A62C 3/00

(52) U.S. Cl. CPC E04B 1/942; A47C 17/38; A62C 3/00

(57) ABSTRACT

Improved methods and systems for operating moveable architectural elements (e.g., furniture) are described. The method includes receiving an indicator of a detection event. The method includes performing a movement of the moveable architectural element from a first position to a second position in response thereto, wherein the second position is selected to reduce an interference of the moveable architectural element with an alleviation system configured to alleviate the detection event. The detection event includes at least one of: fire, carbon monoxide, and smoke. The second position is selected based on a distance of the moveable architectural element from the alleviation system. The second position is selected based on an orientation of the moveable architectural element with respect to the alleviation system. Many other improvements and features are contemplated and described.

### CROSS-REFERENCE TO RELATED APPLICATIONS

This application claims priority to and the benefit of U.S. Provisional Patent Application No. 63/237,362, entitled “SYSTEMS AND METHODS FOR INTEGRATING FIRE SAFETY FEATURES WITHIN ROBOTIC FURNITURE AND INTERIOR ARCHITECTURAL ELEMENTS,” filed on Aug. 26, 2021, the entire contents of which are incorporated herein by reference.

### FIELD OF THE INVENTION

The invention relates generally to apparatuses, systems and methods for implementing modular, moveable architectural elements, and, more specifically, to integrating fire safety features in furniture elements that can be moved and transformed using consumer-friendly controls and mechatronics.

### BACKGROUND

Space-saving, transformable, robotic furniture can be installed in residential buildings, including for the purpose of making small spaces more functional. In many jurisdictions, residential spaces are subject to various codes and standards for fire protection. In the United States, the National Fire Protection Association (NFPA) publishes model standards for fire protect that are widely adopted. As an example, NFPA 13 “Standard for the Installation of Sprinkler Systems” provides for installation requirements for different types of sprinklers, including residential sprinklers, standard spray sprinklers, and extended coverage sprinklers. NFPA 13 includes numerous requirements for different configurations of obstructions that impact sprinkler discharge pattern development for numerous types of sprinklers. It also includes requirements for sprinklers under fixed obstructions and within furniture. Codes and standards adopted in other jurisdictions may have similar requirements. In general, these requirements relate to two principal obstruction scenarios: (1) obstructions or structural/architectural features that are close enough to a sprinkler (or other fire suppression system) as to block/impact sprinkler (or other fire suppression system) discharge pattern development, and (2) obstructions that are far enough away from the sprinkler (or other fire suppression system) that they permit proper sprinkler spray pattern, but that are of a size, or which feature an occupiable space, preventing effective sprinkler discharge (or other fire suppression system discharge).

For purposes of the NFPA standards and standard of other jurisdictions, transformable, robotic furniture and architectural elements may be considered “furniture” and may therefore be exempt from certain fire code requirements. In the case of transformable, robotic furniture and architectural elements, this interpretation may be supported by the fact that these products are designed to be moveable. For example, NFPA 13 states that sprinklers shall not be required to be installed under obstructions that are not fixed in place. Moreover, for example, NFPA 13 states that sprinklers are not required to be installed in furniture such as portable wardrobe units and similar items not intended for occupancy. However, local authorities (known as the Authority Having Jurisdiction (AHJ)) have the responsibility to interpret and apply fire codes and standards (e.g., for particular residential units), and it is possible that an AHJ may take the position that a certain transformable, robotic furniture or architectural element is not furniture, and is therefore subject to applicable fire codes and standards.

If an AHJ's position is that relevant fire codes and standards apply to transformable, robotic furniture and architectural elements in a particular residential unit (or another domain subject to the AHJ), in some cases, sprinkler placement and spray patterns will be such that the residential unit complies with applicable fire codes and standards. In other cases, however, sprinkler placement and spray patterns will be such that the residential unit does not comply with applicable fire codes and standards. Locating additional sprinklers within the residential unit, or upgrading or repositioning existing residential sprinklers, may result in compliance. However, these types of modifications are costly and developers (e.g., real estate developers) may not be willing to absorb the costs necessary to bring non-compliant residential units into compliance.

Therefore, in order to (i) avoid the uncertainties related to fire code and standards interpretation and application: (ii) avoid the costs associated with adding or upgrading fire suppression systems (e.g., sprinklers), or modifying fire suppression system (e.g., sprinkler) location within a residential unit: and (iii) deploy transformable, robotic furniture and architectural elements into residential units at scale, an integrated, product-based solution is necessary. To be effective, this solution must remove the relevant transformable, robotic furniture and architectural element as an obstruction in all situations, regardless of room size and sprinkler location.

### SUMMARY

This disclosure describes an improved moveable architectural element system and operating techniques by incorporating features that solve many of the problems in existing moveable furniture items. The improved features are implemented throughout various elements of the system, including hardware elements, controller elements, and/or software elements.

In one aspect, the invention relates to a method of operating a moveable architectural element. The method can include the steps of: (i) receiving an indicator of a detection event: and (ii) in response thereto, performing a movement of the moveable architectural element from a first position to a second position, wherein the second position is selected to reduce an interference of the moveable architectural element with an alleviation system configured to alleviate the detection event.

In various embodiments of the above aspect, the receiving step can comprise receiving the indicator of the detection event from a detector. In some instances, the detector can comprise at least one of: a smoke detector, a heat sensor, and a CO detector. The detection event can comprise at least one of: fire, carbon monoxide, and smoke. The second position can be selected based on a distance of the moveable architectural element from the alleviation system. The second position can be selected based on an orientation of the moveable architectural element with respect to the alleviation system. The second position can be selected based on both a distance of the moveable architectural element from the alleviation system and an orientation of the moveable architectural element with respect to the alleviation system.

In various embodiments of the above aspect, the alleviation system can comprise a sprinkler. The method can further include the step of: prior to receiving the indicator of the detection event, receiving a selection of the second position. In some instances, the received selection of the second position can be based on a configuration of the alleviation system. The method can further include the step of: after receiving the indicator of the detection event, determining the second position. The method can further include the step of: based on receiving an indicator of a loss of power, performing the movement of the moveable architectural element from the first position to the second position. The interference of the moveable architectural element with the alleviation system can be based on at least one of: an amount of time for the alleviation system to alleviate the detection event and an amount of an alleviation substance provided by the alleviation system to alleviate the detection event. In some instances, the alleviation substance can comprise water. The second position can be selected to eliminate the interference of the moveable architectural element with the alleviation system configured to alleviate the detection event.

In another aspect, the invention relates to a system for operating a moveable architectural element. The system can include a motor adapted to move the moveable architectural element. The system can include at least one of a controller and a data processing apparatus, programmed to perform certain operations. The operations can include: (i) receiving an indicator of a detection event; and (ii) in response thereto, performing a movement of the moveable architectural element from a first position to a second position using the motor, wherein the second position is selected to reduce an interference of the moveable architectural element with an alleviation system configured to alleviate the detection event.

In various embodiments of the above aspect, the receiving step can comprise receiving the indicator of the detection event from a detector. In some instances, the detector can comprise at least one of: a smoke detector, a heat sensor, and a CO detector. The detection event can comprise at least one of: fire, carbon monoxide, and smoke. The second position can be selected based on a distance of the moveable architectural element from the alleviation system. The second position can be selected based on an orientation of the moveable architectural element with respect to the alleviation system. The second position can be selected based on both a distance of the moveable architectural element from the alleviation system and an orientation of the moveable architectural element with respect to the alleviation system.

In various embodiments of the above aspect, the alleviation system can comprise a sprinkler. The operations can further include: prior to receiving the indicator of the detection event, receiving a selection of the second position. In some instances, the received selection of the second position can be based on a configuration of the alleviation system. The operations can further include: after receiving the indicator of the detection event, determining the second position. The operations can further include: based on receiving an indicator of a loss of power, performing the movement of the moveable architectural element from the first position to the second position. The interference of the moveable architectural element with the alleviation system can be based on at least one of: an amount of time for the alleviation system to alleviate the detection event and an amount of an alleviation substance provided by the alleviation system to alleviate the detection event. In some instances, the alleviation substance can comprise water. The second position can be selected to eliminate the interference of the moveable architectural element with the alleviation system configured to alleviate the detection event.

### BRIEF DESCRIPTION OF THE DRAWINGS

In the drawings, like reference characters generally refer to the same parts throughout the different views. Also, the drawings are not necessarily to scale, emphasis instead generally being placed upon illustrating the principles of the invention. In the following description, various embodiments of the present invention are described with reference to the following drawings, in which:

FIG. 1 shows exemplary vertically translating robotic furniture and architectural elements, according to various embodiments:

FIG. 2A shows exemplary horizontally translating robotic furniture and architectural elements, according to various embodiments:

FIG. 2B shows exemplary horizontally translating robotic furniture and architectural elements, according to various embodiments:

FIG. 3 shows a block diagram of an exemplary safe mode system for robotic furniture and architectural elements, according to various embodiments:

FIG. 4 shows exemplary vertically translating robotic furniture and architectural elements including a canopy, according to various embodiments: FIG. 5 shows an exemplary release mechanism for vertically translating robotic furniture and architectural elements including a canopy, according to various embodiments:

FIG. 6 shows an exemplary material for vertically translating robotic furniture and architectural elements including a canopy, according to various embodiments:

FIG. 7 shows an exemplary spot fire protection extinguisher, according to various embodiments: and

FIG. 8 shows an example of a generic computing device, which may be used with the techniques described in this disclosure, according to various embodiments.

### DETAILED DESCRIPTION

This disclosure describes an improved furniture system that incorporates improved fire safety features. The improved features are implemented throughout various elements of the system, including hardware elements, controller elements, and/or software elements. Although this description will often refer to movable furniture elements and, in particular, a dropdown bed furniture item or a moveable wall furniture item, it will be understood that the concepts described herein can be applied to any moveable element, e.g., non-bed furniture items, as well as non-furniture items. Some inventions described in this application build on features described in US Patent Publication Nos. 20200256109 and 20160031090 and International Patent Publication No. WO2020097517, all of which are hereby incorporated by reference in their entireties. Further, although this description will often refer to applications in residential units, it will be understood that the concepts described herein can be applied to any other setting in which sprinklers (or other fire suppression systems) are utilized as a fire safety feature, including commercial, hospitality, industrial, and retail settings.

The various inventive features are described in more detail under separate headings below. However, the headings are provided simply for reader convenience and do not limit the disclosure in any way. Moreover, features described under one heading can be combined with any feature described under any and all other headings in various combinations and permutations.

Within the context of certain features described below, certain aspects may be referred to using the word “requirements.” This or similar words should be interpreted as such description might be used in engineering specification documents, setting forth the requirements only in certain embodiments and in certain conditions. The word requirement, or any other words in this application, should not be interpreted to limit the scope of the described or claimed invention nor to mean that in different embodiments and under different conditions, such requirements may not be required.

### Safe Mode for Translating Systems

When pieces of equipment are required to “move” (e.g., “translate”) in order to operate properly for fire code and life safety purposes (such as fire-resistance rated doors), they typically are required to move (e.g., open) to a safe position upon loss of power. In the same way, robotic furniture and architectural elements can be designed to move to a “safe position” based on a trigger (e.g., a predesignated trigger). In this safe position, the robotic furniture and architectural element would not be an obstruction or would be a reduced obstruction to an alleviation system and related discharge and would be in compliance with relevant codes and standards (e.g., fire codes and standards). The safe position may eliminate or reduce a moveable element's interference with an alleviation system. An “alleviation system” may refer to fire suppression systems (e.g., sprinklers, hoses, extinguishers, etc.) and/or other suppression devices that are configured to alleviate a fire or emergency event (referred to as a “detection event”). “Alleviation” of a detection event may refer to providing an output configured to reduce, stop, and/or otherwise suppress the detection event.

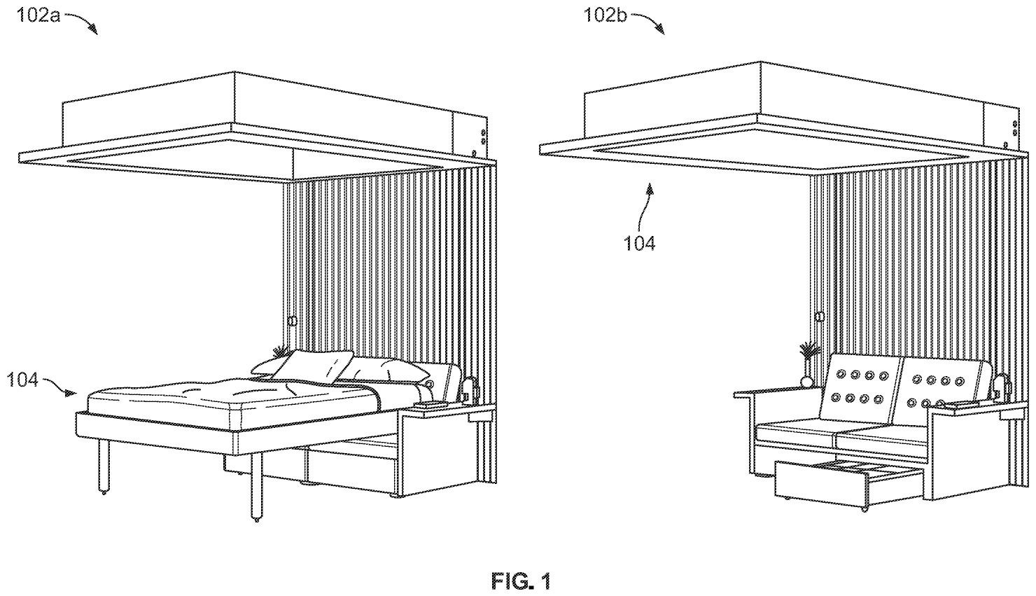

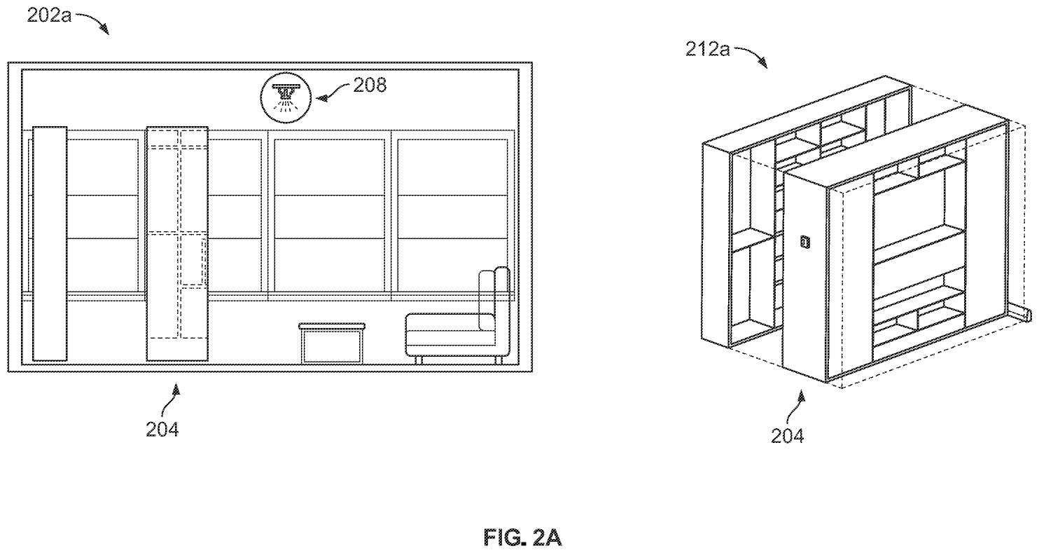

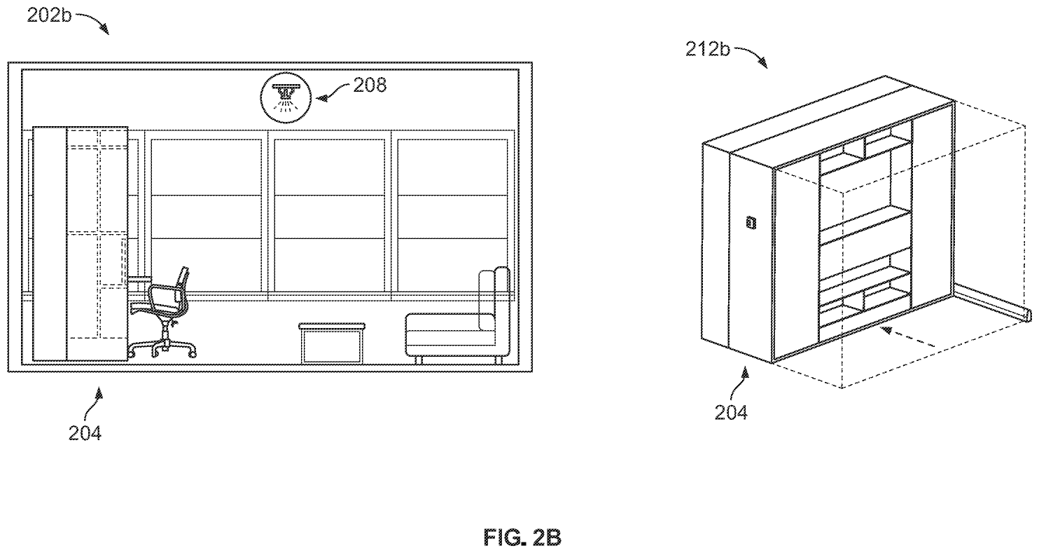

Each robotic furniture and architectural element (e.g., as described with respect to FIGS. 1 and 2A-2B) may include at least one moveable architectural element that can move to a “safe position” determined: (1) by a room size, dimensions and alleviation system location(s): (2) by a distance and/or an orientation of a moveable architectural element relative to the alleviation system location(s): and/or (3) in accordance with AHJ determinations. In some cases, a safe position may be selected (e.g., by a user or installer) using one or more input devices of a robotic furniture and architectural element. In some cases, a safe position may be automatically determined and selected by a safe mode system (e.g., using one or more sensors). Examples of robotic furniture and architectural elements configured to move to a safe position are described herein.

### Safe Mode for Vertically Translating Systems

FIG. 1 shows exemplary embodiments of vertically translating robotic furniture and architectural elements. A configuration 102a of vertically translating robotic furniture and architectural elements shows a moveable element 104 in a lowered position. A configuration 102b of vertically translating robotic furniture and architectural elements shows a moveable element 104 in a raised position. In some embodiments of vertically translating robotic furniture and architectural elements, an element 104 may be vertically translated (e.g., raised), such that the element 104 is in an up-most position as shown in the configuration 102b. When the element 104 is raised (e.g., a bed as shown in FIG. 1) to or near the up-most position of the configuration 102b, the element 104 could be close enough to an alleviation system (e.g., sprinkler head or other fire suppression device), whether located in the ceiling or elsewhere, to be considered an obstruction (e.g., by an AHJ). When the element 104 is lowered (e.g., the bed as shown in FIG. 1) to or near the lowered position of the configuration 102a, the sprinkler and sprinkler spray (or other fire suppression substance) may no longer be obstructed or may be less obstructed than the first position and the full (or otherwise compliant) spray pattern may be discharged. In some cases, a safe position for vertically translating robotic furniture and architectural elements may correspond to the configuration 102a, where the element 104 does not obstruct an alleviation system located on a ceiling and/or wall. In other cases, a safe position for vertically translating robotic furniture and architectural elements may correspond to a configuration where the element 104 is positioned between the positions of the element 104 corresponding to the configurations 102a and 102b. The safe position for vertically translating furniture and architectural elements may be configured based on a position of alleviation systems and based on the selectable positions and/or orientations of a moveable element 104.

### Safe Mode for Horizontally Translating Systems

FIGS. 2A and 2B show exemplary embodiments of horizontally translating robotic furniture and architectural elements. Configurations 202a and 212a of horizontally translating robotic furniture and architectural elements shows a moveable element 204 in an open position. Configurations 202b and 212b of horizontally translating robotic furniture and architectural elements shows a moveable element 204 in a closed position. For horizontally translating robotic furniture and architectural elements, when the element 204 is opened (e.g., as in configurations 202a and 212a) or moved to a first position, the element 204 could be close enough to an alleviation system (e.g., sprinkler head or other fire suppression device), whether located in the ceiling, wall, or elsewhere, to be considered an obstruction. When the element 204 is closed (e.g., as in configurations 202b and 212b) or moved to a second position, the sprinkler (or other fire suppression device) may no longer be obstructed or may be less obstructed than the first position and may be able to discharge a full (or otherwise compliant) spray pattern. In some cases, a safe position for horizontally translating robotic furniture and architectural elements may correspond to the configurations 202b and 212b, where the element 204 does not obstruct an alleviation system located on a ceiling and/or a wall. In other cases, a safe position for horizontally translating robotic furniture and architectural elements may correspond to a configuration where the element 204 is positioned between the positions of the element 104 corresponding to the configurations 202a and 212a and the configurations 202b and 212b. The safe position for horizontally translating furniture and architectural elements may be configured based on a position of alleviation systems and based on the selectable positions and/or orientations of a moveable element 204.

The foregoing examples are illustrative and different embodiments could exist for different robotic furniture and architectural elements depending on the situation. Moreover, in order to be most effective, the “safe positions” for robotic furniture and architectural elements may be adjustable during installation and/or after installation (e.g., using input devices included in the robotic furniture and architectural elements and/or determined automatically by a safe mode system).

To have an effective “safe mode” that causes moveable element(s) of robotic furniture and architectural elements to move to safe position(s), robotic furniture and architectural elements may include a “safe mode” system that can detect an indicator of a detection event (e.g., an increase in temperature or another predetermined trigger) and cause the movement of a moveable element (or elements) of the robotic furniture and architectural elements to a safe position before sprinklers begin discharging water (or other alleviation systems are activated). By triggering a moveable element (or elements) of the robotic furniture and architectural elements to move to a safe position, the robotic furniture and architectural elements may not be an obstruction or may be a reduced obstruction to an alleviation system. In some cases, the safe mode system may be separate (e.g., not physically or communicatively connected) from external systems corresponding to a residential unit. External systems may include structural, electrical, and life safety systems corresponding to a residential unit or a building that includes the residential unit. As such, the safe mode system can be integrated within the robotic furniture and architectural elements and may include all necessary functionality in a self-contained system. That is, the integrated safe mode system may include one or more sensors, detectors, and/or digital logic (e.g., software stored on a computer readable-medium) and may be separated from the other external (e.g., building) systems that may exist to detect and/or extinguish a fire (e.g., smoke alarms, carbon monoxide (CO) monitors, and/or sprinkler systems). The safe mode system may enable robotic furniture and architectural elements to function as a standalone, separate apparatus within a residential unit that can measure an indicator of a detection event and activate a safe mode to move one or more of its moveable elements to a safe position, such that the robotic furniture and architectural elements are not an obstruction or are a reduced obstruction to external systems that are configured to detect and suppress a fire (or cause of an emergency event). Some non-limiting examples of an indicator of a detection event (e.g., fire and/or another emergency) can be an increase in temperature, smoke, and/or CO.

In some embodiments, a position of a moveable architectural element may be based on a distance and/or an orientation of a moveable architectural element with respect to an alleviation system. A safe position may correspond to the moveable architectural element being positioned at a particular distance and/or orientation with respect to the alleviation system such that the moveable architectural element provides a reduced level of obstruction or no obstruction to the alleviation system. A level of obstruction and/or interference that a moveable architectural element poses to an alleviation system may be based on (e.g., measured) using one or more alleviation factors that indicate a level of obstruction and/or interference to an alleviation system relative to when robotic furniture and architectural elements are not present. In some cases, an alleviation factor may include an amount of time required for an alleviation system to alleviate a detection event. For example, an amount of time required for a sprinkler to extinguish a fire may be an alleviation factor used to evaluate a level of obstruction posed by a moveable architectural element. In some cases, an alleviation factor may include an amount of an alleviation substance (e.g., water or other fire suppressant substance) required to be output by an alleviation system to alleviate a detection event. For example, an amount of water required to be output by a sprinkler to extinguish a fire may be an alleviation factor used to evaluate a level of obstruction posed by a moveable architectural element. In some cases, an alleviation factor may include an output rate (e.g., gallons per minute) of an alleviation substance required to be output by an alleviation system to alleviate a detection event.

In a room without robotic furniture and architectural elements, an alleviation system may be positioned such that there is not an obstruction to the alleviation system (e.g., sprinkler) and discharge (e.g., water). When a room is provided with robotic furniture and architectural elements, an included moveable architectural element can obstruct and/or interfere with an alleviation system as described herein. When the moveable architectural element is moved from a first (e.g., current) position to a safe position, a distance and/or an orientation of the moveable architectural element may be adjusted relative to the alleviation system. Based on moving the moveable architectural element from the first (e.g., previous) position to the safe position, a level of obstruction and/or interface posed by the moveable architectural element to the alleviation system may be reduced or eliminated. At the safe position, the moveable architectural element may provide a reduced level of interference and/or obstruction to the alleviation system relative to any other position (e.g., selectable position) of the moveable architectural element.

In some embodiments, as described herein, a level of obstruction and/or interference that a moveable architectural element poses to an alleviation system can be based on alleviation factors including an amount of time required for an alleviation system to alleviate a detection event, an amount of an alleviation substance required to be output by an alleviation system to alleviate a detection event, and/or an output rate of an alleviation substance required to be output by an alleviation system to alleviate a detection event. By moving a moveable architectural element to a safe position from a previous position, one or more of the alleviation factors described herein may be reduced by a difference of, for example, 10%, 20%, 30%, 40%, 50%, etc., from the value of the alleviation factor at the previous position. In some cases, by moving a moveable architectural element to a safe position from a previous position, one or more of the alleviation factors described herein may be reduced to be no greater or, for example, 1%, 5%, 10%, 20%, etc., greater than the value of the alleviation factor for alleviation system when the robotic furniture and architectural elements are not present. As an example, when a moveable architectural element is located at a first position that interferes with a sprinkler, the sprinkler may be required to output 50% more water to extinguish a fire present in a room relative to when the room does not include the moveable architectural element. When the moveable architectural element is moved from the first position to a safe position with respect to a sprinkler, the sprinkler may be required to output 1-10% more or no more water to extinguish a fire present in a room relative to when the room does not include the moveable architectural element.

In some cases, by moving a moveable architectural element to a safe position from a previous position, one or more of the alleviation factors described herein may be reduced, for example, to be equivalent to the values of the alleviation factors for the alleviation system when the robotic furniture and architectural elements are not present in the room. As an example, when the moveable architectural element is moved from the first position to a safe position with respect to a sprinkler, the moveable architectural element may not obstruct or interfere with the sprinkler, such that the sprinkler may output an equivalent amount of water to extinguish a fire present in a room relative to when the room does not include the moveable architectural element.

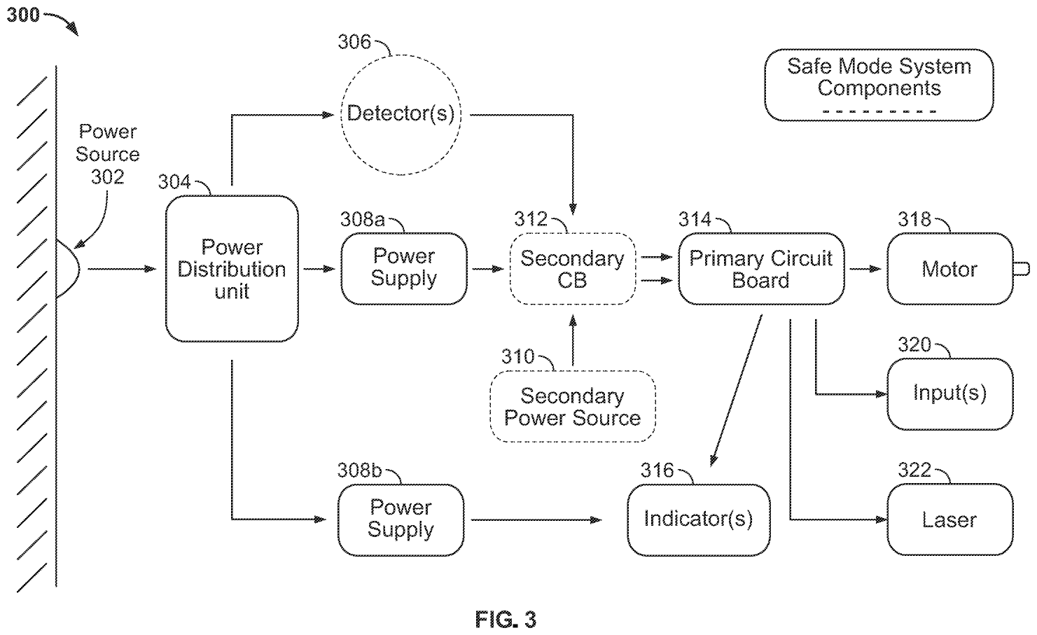

FIG. 3 shows an exemplary block diagram of a safe mode system 300 for robotic furniture and architectural elements. The block diagram of FIG. 3 shows supplementary safe mode system components (shown in dashed lines), including the detector(s) 306, secondary power source 310, and secondary circuit board 312 that are connected to an existing electrical system (shown in solid lines) of exemplary robotic furniture and architectural elements to form the safe mode system 300. The components as shown in FIG. 3 may communicate and/or otherwise interface in a closed loop without connection to external (e.g., building) systems (except for receiving power (e.g., AC power) from an external connection).

As shown in FIG. 3, the safe mode system 300 may include a power distribution unit 304, one or more detectors 306, one or more power supplies 308, a secondary power source 310, a secondary circuit board 312, a primary circuit board 314, one or more indicators 316, a motor 318, one or more inputs 320, and a laser 322. The safe mode system 300 may couple to an external power source 302 (e.g., a wall outlet) via the power distribution unit 304. In some cases, the primary circuit board 314 and/or the secondary circuit board 312 may be a printed circuit board (PCB). The one or more indicators 316 may include lights and/or screens configured to provide an indication of a state of operation of the robotic furniture and architectural elements. For example, the indicators 316 may provide a visual indication of the safe mode system 300 activating and moving the moveable architectural element to a safe position. The motor 318 may be used to drive a moveable element of the robotic furniture and architectural elements between positions. The one or more inputs 320 may include controls (e.g., buttons, knobs, sliders, touch sensitive screens, etc.) used to operate a robotic furniture and architectural element. In some cases, the one or more inputs 320 may include controls used to select a safe position of a moveable architectural element of robotic furniture and architectural elements. The laser 322 may be used to track a position (e.g., a distance and/or orientation) of a moveable architectural element. For example, the secondary circuit board 312 and/or the primary circuit board 314 may track a position of a moveable architectural element based on measurement(s) collected by the laser 322.

In some embodiments, the power distribution unit 304 and/or the secondary power source 310 may provide power to the detector(s) 306. The detector(s) 306 may provide data to the secondary circuit board 312. For example, the detector(s) 306 may provide a measured indication of a temperature, smoke level, and/or CO level as data to the secondary circuit board 312. In some cases, the secondary circuit board 312 may provide data and/or power to the primary circuit board 314. For example, the secondary circuit board 312 may provide a 3.3 V power signal to the primary circuit board 314. The secondary circuit board 312 and/or the primary circuit board 314 may receive an indicator of a detection event from the detector(s) 306. In some cases, the secondary circuit board 312 and/or the primary circuit 314 board may receive an indicator of a loss of power from the power source 302. Based on the received indicator of the loss of power, the secondary circuit board 312 and/or the primary circuit board 314 may cause moveable element(s) to move to a safe position as described herein.

In some embodiments, the safe mode system 300 can include one or more sensors 306 (also referred to as “detectors 306”) configured to (1) measure a parameter of a fire or emergency event (referred to as a “detection event”) and (2) provide, based on the measured parameter corresponding to an indicator of the detection event, an indicator of the detection event to a controller (e.g., primary circuit board 314) of a moveable furniture to cause movement of a moveable element to a safe position. An indicator of a detection event may indicate an identification of a fire, smoke, CO, etc. In some cases, a measured parameter of a detection event that exceeds a threshold value may be an indicator of a detection event and may cause movement of a moveable architectural element to a safe position. A detector 306 may be a sensor (e.g., integrated sensor) of the safe mode system 300 that is configured to measure temperature, changes in temperature, smoke, and/or CO in an area adjacent and/or proximal to the detector 306. In some cases, the detector 306 located within robotic furniture and architectural elements may adhere to jurisdictional standards (e.g., NFPA 72 standards). The detector 306 may measure a temperature, a change in temperature, a smoke level, and/or a CO level to identify a detection event. As an example, a measured temperature and/or a measured change in temperature may correspond to heat from a fire in a residential unit.

In some embodiments, the detector 306 (or circuitry coupled to the detector) may compare a measurement for a temperature, a change in temperature, a smoke level, and/or a CO level to one or more thresholds. In some cases, based on a measurement exceeding one or more of the thresholds, the detector 306 may send an indication (e.g., an electrical signal) of the detection event to a controller (e.g., primary circuit board 314) of moveable furniture and architectural elements. In some cases, a detector 306 may identify a detection event by alternative detection methods may send an indication (e.g., an electrical signal) of the detection event to the controller (e.g., primary circuit board 314) of moveable furniture and architectural element. Based on receiving the indication from the detector 306, a controller of the moveable furniture and architectural elements may cause moveable element(s) to move to a safe position as described herein. For example, a detector 306 (or circuitry coupled to a detector 306) may measure a threshold level of smoke in an area surrounding the detector 306 and may cause movement of a moveable architectural element from a current position to a safe position based on the measured smoke level. In some cases, the detector 306 may send the indication before an activation of alleviation systems (e.g., sprinklers or other fire suppression systems) configured to extinguish a fire in a residential unit.

In some cases, a detector 306 may be approved and/or otherwise recognized by an external organization (e.g., a safety organization). For example, a detector may be Underwriters Laboratories listed (UL-listed), Factory Mutual (FM) approved, and/or NFPA approved. Examples of types of detectors 306 that can be used to measure temperature or other indicators (e.g., smoke, CO, etc.) of a detection event are described herein.

In some cases, a detector 306 as described herein may be or include a spot heat detector. A spot (e.g., fixed temperature) heat detector may be sensor that is configured to trigger (e.g., send an indicator) when an ambient temperature measured by the spot heat detector reaches or exceeds a fixed temperature threshold. The fixed temperature threshold may be a temperature that is indicative a fire in an area adjacent or proximal to the spot heat detector (and/or associated robotic furniture and architectural elements). A spot heat detector may be a highly cost-effective solution for many property protection applications. If a rapid response to a fire is a requirement for the safe mode system, a rate-of-rise heat detector may be used to detect rapid temperature increases (e.g., temperature increases that would be caused by a fire emergency). Conventional residential sprinklers are normally rated at 155° F., where the sprinklers may activate based on the ambient temperature reaching 155° F. A heat detector that triggers at a lower temperature (e.g., at 120° to 135° F.) than the heat detector associated with fire suppression systems may be preferred for use as a detector in the safe mode system. A difference in the threshold temperature for triggering the safe mode system 300 and the fire suppression system(s) may enable the safe mode system 300 to trigger and cause element(s) of the robotic furniture and architectural elements to move a safe position before the activation of the fire suppression system(s). In some cases, heat detectors (e.g., spot, rate-of-rise, etc.) are conventionally hardwired to a power source 302 (e.g., an AC power source) and may include an integrated secondary power source 310 (e.g., a battery) as described herein. The integrated secondary power source 310 may enable a heat detector (or any other detector 306) and the motor 318 to operate in events of disconnection or power loss from a power source 302.

In some cases, a detector 306 as described herein may be or include a linear heat detector. A linear heat detector may include one or more linear heat detection cables. The linear heat detection cables may include advanced polymer and digital technologies that enable the linear heat detector to measure temperature (e.g., heat) conditions anywhere along the length of the cable. The cable may be composed of two zinc-coated spring steel conductors. Each zinc-coated spring steel conductor may be coated with a heat-sensitive thermoplastic polymer that is configured (e.g., engineered) to melt at a fixed temperature threshold. If the polymer reaches the fixed temperature threshold, the polymer may melt and the conductors may contact with one another. Based on the contact of the conductors, circuitry coupled to the conductors may send an indicator (e.g., an electrical signal) to a controller (e.g., primary circuit board 314 of the safe mode system 300) via the contacting conductors. Based on receiving the indicator, the controller may sound an alarm, cause activation of fire suppression systems, or cause element(s) of the robotic furniture and architectural elements to move from a current position to a safe position.

In some cases, a detector 306 as described herein may be or include a smoke detector and/or a CO detector. A combination smoke and CO detector may detect both smoke and CO in a single apparatus. Alternately, a smoke detector and a CO detector may be separate apparatuses. These detectors are widely used in residential buildings because they can activate and detect a fire faster (e.g., due to greater sensitivity) than heat detectors (e.g., spot, rate-of-rise, linear, etc.). However, the sensitivity of the smoke and CO detector may trigger false positive alarms. Based on detecting a threshold amount of smoke and/or CO, circuitry coupled to the detector(s) may send an indicator (e.g., an electrical signal) to a controller (e.g., controller of the safe mode system). Based on receiving the indicator, the controller may sound an alarm, cause activation of fire suppression systems, or cause element(s) of the robotic furniture and architectural elements to move from a current position to a safe position.

In some embodiments, the safe mode system 300 may include a secondary (e.g., backup) power source 310. In some cases, the secondary power source 310 may be a battery. In some cases, the power distribution unit 304 and/or the power supply 308a may supply power to charge the secondary power source 310 based on the power source 302 providing power to the power distribution unit 304. In the event of a power outage to the robotic furniture and architectural element and/or the safe mode system 300 (e.g., based on the power source 302 no longer providing power to the power distribution unit 304), the secondary power source 310 can activate to provide power to the robotic furniture and to the safe mode system 300 for operational continuity. In some cases, the secondary power source 310 may provide power to the detector(s), the secondary circuit board 312, the primary circuit board 314, the motor 318, and/or the laser 322. While operating using the secondary power source 310, one or more features of the safe mode system 300 may be disabled and/or otherwise limited to maximize the longevity/lifespan of the secondary power source 310. For example, the one or more inputs 320 may disabled such that a user cannot control a position of a moveable architectural element to conserve power for the secondary power source 310. The safe mode system 300 may determine an expected longevity/lifespan of the secondary power source 310. If power has not been restored to the safe mode system 310 prior to an expiration of the expected secondary power source lifespan, the safe mode system 300 may automatically activate “safe mode” to cause a moveable element to move to a safe position as a preventative safety measure regardless of whether an indicator of a detection event (e.g., fire and/or emergency event) has been detected (e.g., as a result of measuring temperature, smoke, and/or CO). Once power is restored to the robotic furniture or architectural element (including the safe mode system), the secondary power source 310 can be recharged.

In some embodiments, the safe mode system 300 may include a secondary circuit board 312. A secondary circuit board 312 may receive a communication (e.g., electrical signal) from the detector(s) 306 as an input. Based on receiving the communication, the secondary circuit 312 may send a communication (e.g., electrical signal) to the primary circuit board 314 of the robotic furniture or architectural element to command a movement of a moveable architectural element (e.g., bed, wall, etc.) to a safe position. In some cases, the secondary circuit board 312 may receive power from the secondary power source 310 and may provide the primary circuit board 314 with power from the secondary power source 310 if the safe mode system 300 is disconnected from the power source 302 and/or otherwise loses power. The secondary power source 310 may power the secondary circuit board 312 and the primary circuit board 314 in event of power loss such that main safety features (e.g., movement to a safe position) of the safe mode system 300 may remain operable.

In some cases, the safe mode system 300 may include one or more sensors (not shown in FIG. 3) configured to determine a safe position for moveable architectural elements. The one or more sensors may identify a location of alleviation system(s) in a room and a controller (e.g., secondary circuit board 312 and/or primary circuit board 314) may determine a safe position for a moveable architectural element based on the identified location of the alleviation system(s) and the selectable distance and/or orientation of the moveable architectural element relative to the alleviation system(s). The one or more sensors may include optical sensors (e.g., cameras, infrared sensors, etc.) configured to identify a location of the alleviation system(s) in a room. In some cases, the one or more sensors may configured to determine a safe position in real-time based on a detection of an indicator of a detection event. As an example, a controller (e.g., secondary circuit board 312 and/or primary circuit board 314) of robotic furniture and architectural elements may receive an indicator of a detection event (e.g., from a detector 306) and may cause, based on (e.g., upon) receiving the indicator of the detection event), the one or more sensors to automatically determine a safe position for a moveable architectural element. Based on determining the safe position, the controller may move the moveable architectural element to the safe position determined by the one or more sensors.

### Canopy Safety Features

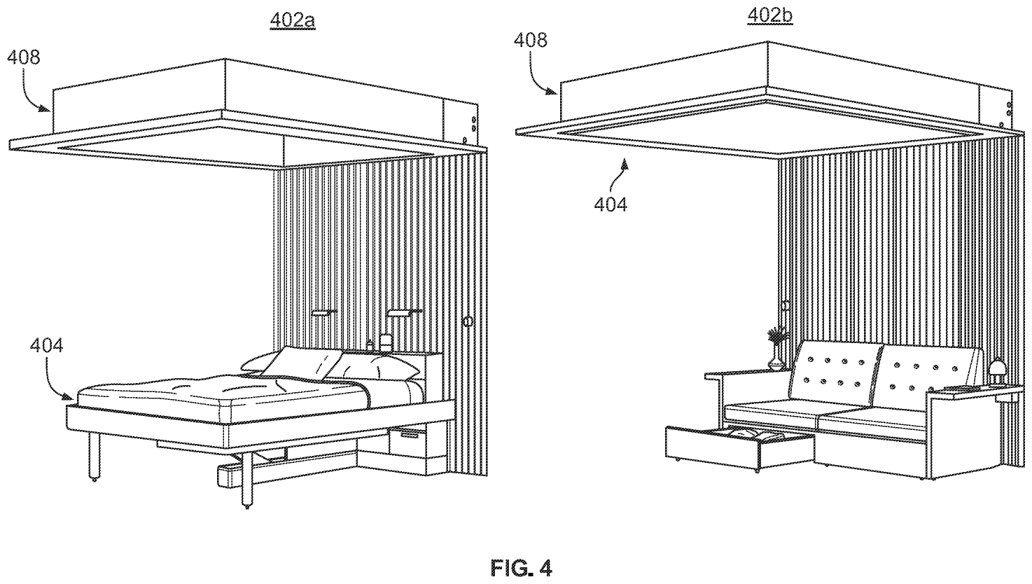

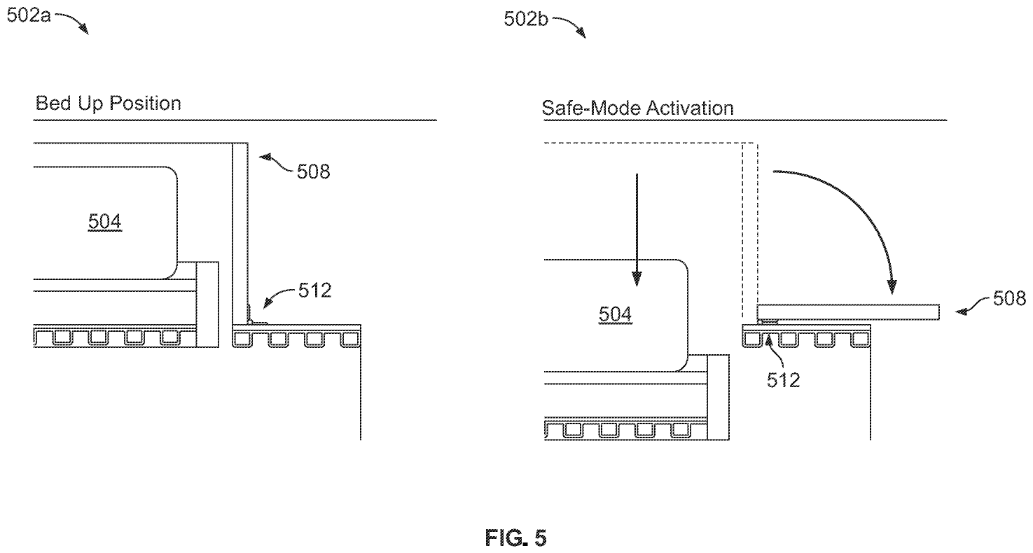

In some embodiments, robotic furniture and architectural elements may include a canopy or other extended or suspended object. Such canopies or objects may impede or otherwise obstruct fire suppression systems (e.g., sprinkler spray) when mounted (e.g., adjacent or proximal to a ceiling and/or wall) in a residential unit. FIG. 4 shows exemplary embodiments of vertically translating robotic furniture and architectural elements including a canopy. A configuration 402a of vertically translating robotic furniture and architectural elements shows a moveable element 404 in a lowered position. A configuration 402b of vertically translating robotic furniture and architectural elements shows a moveable element 404 in a raised position. Both configurations 402a and 402b of the vertically translating robotic furniture and architectural elements show a canopy 408. The canopy 408 may be mounted adjacent and/or proximal to a ceiling and/or a wall.

In some embodiments, to prevent a canopy 408 (or similar extended or suspended feature) of robotic furniture and architectural elements from obstructing alleviation systems, the robotic furniture and architectural elements may be configured to use one or more canopy safety features with the safe mode system (e.g., safe mode system 300) as described herein.

In some embodiments, canopy safety features can include a canopy release mechanism. A canopy release mechanism may trigger based on detection of an indicator of a detection event as described herein with respect to a safe mode system and movement of a moveable architectural element from a current position to a safe position. For example, based on a detector (e.g., detector 306) measuring a threshold temperature or detecting smoke/CO, a canopy release mechanism may trigger and cause movement of the canopy 408 as described herein.

Robotic furniture and architectural elements may be configured with a canopy release mechanism. FIG. 5 shows an exemplary embodiment of a canopy release mechanism in an exemplary embodiment of robotic furniture and architectural elements. A configuration 502a of vertically translating robotic furniture and architectural elements shows a moveable element 504 in a raised position and a canopy in a standard position. A configuration 502b of vertically translating robotic furniture and architectural elements shows a moveable element 504 in a partially lowered position and a canopy 508 in a safe position. A safe position of a canopy 508 may correspond to a position where the canopy 508 does not obstruct a fire suppression system. With a canopy 508 (or other extended or suspended object) that has side panels (e.g., exemplary robotic furniture and architectural elements having an L-shape profile along three sides (footboard and two sides)), the vertical panels of the canopy 508 can be released (e.g., dropped or folded down) based on a detector (e.g., detector 306) measuring an indicator (e.g., temperature, smoke level, CO level, etc.) of a detection event. For example, vertical panels of the canopy 508 may release and move from the configuration 502a to the configuration 502b based on a detector measuring temperatures exceeding a temperature threshold. A trigger that causes execution of the canopy release mechanism may be the same as the trigger as described herein for a safe mode system (e.g., with respect to FIG. 3). When the vertical panels of the canopy 508 fold down to the configuration 502b, the canopy 508 may no longer be an obstruction to an alleviation system (e.g., sprinklers or sprinkler spray).

In some cases, as shown in FIG. 5, the vertical panels of the canopy 508 can be fitted with hinges 512 (spring-loaded hinges) having a natural position of a released or folded-down position (e.g., as shown in configuration 502b). A holding mechanism (e.g., solenoids or magnets) may keep the vertical panels of the canopy 508 and the hinge 512 in a vertical position (as shown in the configuration 502a) until the canopy release mechanism is activated. When the canopy release mechanism is activated (e.g., based on a trigger), a detector (or circuitry coupled to the detector) may send a communication (e.g., electrical signal) to the holding mechanism to retract and/or otherwise deactivate. Based on the holding mechanism retracting and/or otherwise deactivating, the vertical panels of the canopy 508 to may drop or fold downward from the configuration 502a to the configuration 502b. With the vertical panels dropped or folded downward, the canopy 508 may not be an obstruction to an alleviation system and may comply with relevant fire codes and standards. The vertical panels of the canopy 508 may remain in the downward or folded position and in a reduced-profile state until they are manually or automatically reset/replaced with the holding mechanism reengaged.

In some cases, one or more alternative holding mechanisms can be used to remove a canopy 508 as an obstruction. In some cases, an alternative holding mechanism may be a fusible link. A mechanical fusible link is a device that can include two strips of metal soldered together with a fusible alloy, where the fusible allow is designed to melt at a specific temperature. Based on the fusible link reaching the specific temperature, the fusible alloy may melt and the two stops of metal may separate. Accordingly, the fusible link may operate as a combination of a detector and a holding mechanism. In a normal state (e.g., when the temperature of fusible alloy is below its melting temperature), the fusible link can hold the vertical panels of the canopy 508 upward in a configuration 508 and can act as a holding mechanism. When the fusible link temperature increases (e.g., due to a fire) and exceeds a threshold value, the fusible alloy can melt and the two metal pieces can separate, releasing the vertical panels of the canopy 508. The fusible links can be rated to separate at one or more temperatures, such that fusible links may be selected with a rating (e.g., melting point) suitable to configure a temperature differential between an activation temperature of an alleviation system and a melting temperature of the fusible link.

In some embodiments, an alternative holding mechanism may be a polyvinyl alcohol (PVA) material. PVA is a water-soluble synthetic polymer. PVA is commonly used in the fishing industry, as supporting material in 3D printing, and in dishwashing pods among other applications. PVA can be manufactured in different forms and shapes: strings, cords, bags, meshes, grids, films, etc. In some embodiments, PVA can be used in the form of a string surrounding the canopy, acting as the holding mechanism and keeping the vertical panels up. PVA may be water soluble, such that the PVA may fail as a holding mechanism for the vertical panels of the canopy 508 when subjected to a threshold amount of water (or other solvent). Based a threshold amount of water (e.g., from a sprinkler) reaching the PVA string, the PVA string may dissolve, releasing the vertical panels of the canopy 508. Any other suitable PVA structure may be used as a holding mechanism for a canopy 508 of robotic furniture and architectural elements.

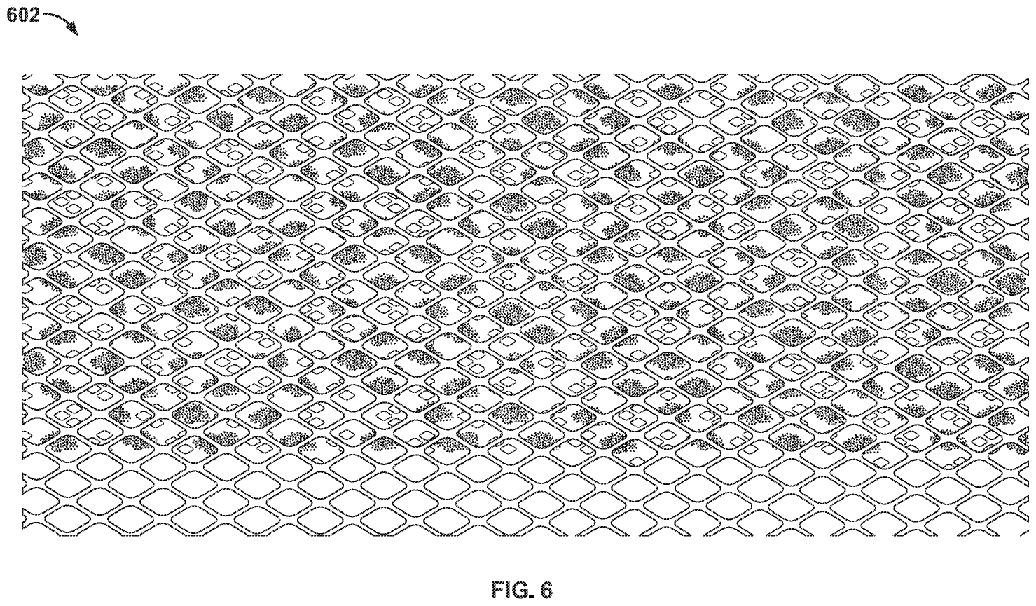

In some embodiments, an alternative holding mechanism may be a metallic grid and water soluble cover. In order to remove (or significantly limit) a canopy 508 or another suspended object as an obstruction to alleviation systems (e.g., sprinklers and sprinkler spray), materials used in construction of the canopy 508 may be made compliant. In some cases, a canopy 508 may be constructed of a metallic mesh (or other suitable mesh material) that can provide the necessary structural stability for the robotic furniture. FIG. 6 shows an example of metallic mesh 602 with 70% permeability. The metallic mesh 602 of a canopy (e.g., canopy 508) may be surrounded by a water soluble cover material, which may provide an aesthetic and finished appearance to the canopy. Some examples of cover materials may include paper or similar dissolvable material. When exposed to water from sprinklers, the cover may dissolve to expose the metallic mesh. Depending on jurisdictional requirements, the metallic mesh must have a permeability of a minimum percentage. In an example, the metallic mesh may have a minimum permeability of 70%.

In some embodiments, an alternative holding mechanism may be a fabric curtain. The vertical panels of the canopy 508 (or other suspended object) may be composed of fabric curtains that are fully extended in their normal state. When an alleviation system (e.g., sprinkler) activates, the fabric curtains may absorb water. As the fabric curtains absorb water, they may become heavier and may release/drop when the weight has increased to a sufficient level. Once released/dropped, the fabric curtains may not be an obstruction to discharge from the alleviation system.

The alternative holding mechanisms described above that trigger a canopy safety feature (e.g., release mechanism) only following an activation of a fire suppression system (e.g., sprinklers) may block the system spray for a period of time before the walls of the canopy 508 release or drop. These alternatives may include, for example, the PVA material string or structure, the metallic mesh and water soluble cover, and the fabric curtain. As a result, as compared to methods that trigger prior to the activation of sprinklers (e.g., the fusible links), alternatives that rely on the activation of sprinklers to trigger may deploy later, may be less effective, and may not comply with applicable fire codes and standards.

### Integrated Fire Suppression Systems

Systems and methods for integrating fire safety features within robotic furniture and architectural elements as described herein have been designed to detect a feature of a fire (e.g., heat, smoke, CO, etc.) or other emergency event and trigger an action intended to remove or reduce an effect of an obstruction from an alleviation system (e.g., sprinklers or sprinkler spray). In some cases, alleviation systems or features may be integrated into robotic furniture and architectural elements that could be capable of extinguishing a fire and could provide additional alleviation (e.g., fire suppression_ in addition to existing alleviation systems (e.g., sprinklers or other fire suppression) located in the residential unit. Such alleviation systems and features may be used with the safe mode system and canopy safety features as described herein. For example, an automatic spot protection fire extinguisher integrated into robotic furniture could provide supplementary fire protection.

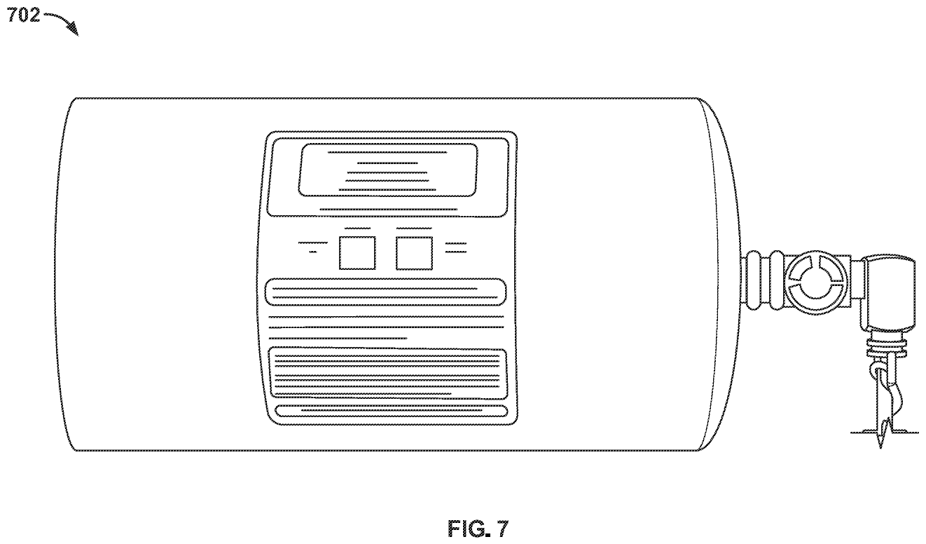

FIG. 7 shows an exemplary spot protection figure extinguisher 702 that may be integrated with robotic furniture and architectural elements. The spot protection fire extinguisher 702 may be designed, constructed, and tested to the same standard (e.g., engineering and/or quality standards) as portable fire extinguishers. The spot protection fire extinguisher 702 may be available in horizontal or vertical configurations. The spot protection fire extinguisher 702 can be charged with fire suppression agents (e.g., multipurpose dry chemical or Halotron agents). The spot protection fire extinguisher 702 may typically be fitted with a sprinkler head that is rated at 155° F. to 165° F., but could also be rated at a different temperature, such that the spot protection fire extinguisher 702 activates when a detector (e.g., temperature sensing device) of the fire extinguisher reaches its rated threshold. If integrated into robotic furniture and architectural elements, the spot protection fire extinguisher 702 could be integrated in a location suitable to achieve a maximum fire suppression effect in the event that it is triggered. Using in conjunction with the safe mode and/or canopy safety features described above, an integrated spot protection fire extinguisher 702 can be a fail-safe that provides fire suppression coverage in any fire scenario. For example, an integrated spot protection fire extinguisher 702 may provide fire suppression coverage in the case of failure of the safe mode and/or the canopy safety features.

### Operating Apparatus

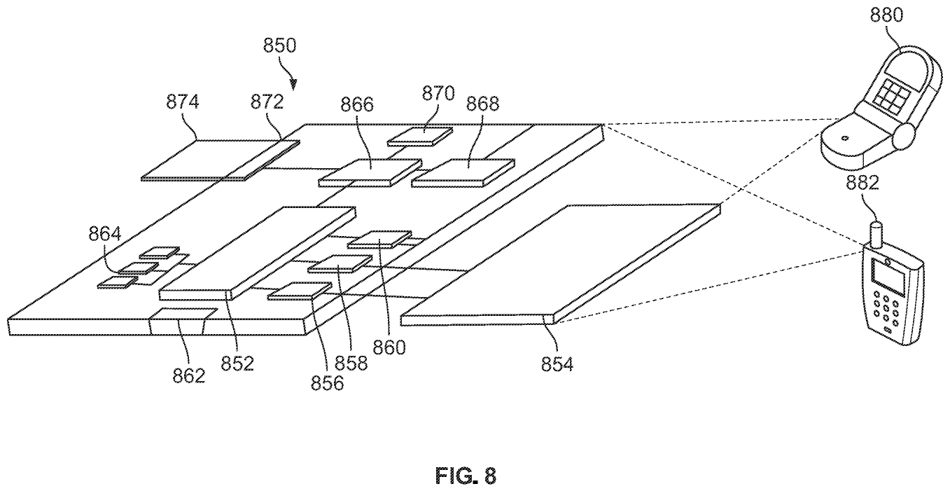

FIG. 8 shows an example of a generic computing device 850, which may be used with the techniques described in this disclosure. Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can execute instructions within the computing device 850, including instructions stored in the memory 864. The processor may be implemented as a chipset of chips that include separate and multiple analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT LCD (Thin-Film-Transistor Liquid Crystal Display) or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be provided in communication with processor 852, so as to enable near area communication of device 850 with other devices. External interface 862 may provide, for example, for wired communication in some implementations, or for wireless communication in other implementations, and multiple interfaces may also be used.

The memory 864 stores information within the computing device 850. The memory 864 can be implemented as one or more of a computer-readable medium or media, a volatile memory unit or units, or a non-volatile memory unit or units. Expansion memory 874 may also be provided and connected to device 850 through expansion interface 872, which may include, for example, a SIMM (Single In Line Memory Module) card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provided as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer-or machine-readable medium, such as the memory 864, expansion memory 874, memory on processor 852, or a propagated signal that may be received, for example, over transceiver 868 or external interface 862.

Device 850 may communicate wirelessly through communication interface 866, which may include digital signal processing circuitry where necessary. Communication interface 866 may in some cases be a cellular modem. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, WiFi, or other such transceiver (not shown). In addition, GPS (Global Positioning System) receiver module 870 may provide additional navigation-and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, etc.) and may also include sound generated by applications operating on device 850.

The computing device 850 may be implemented in a number of different forms, as shown in FIG. 8. For example, it may be implemented as a cellular telephone 880. It may also be implemented as part of a smartphone 882, smart watch, personal digital assistant, or other similar mobile device.

### Operating Environment

Implementations of the subject matter and the operations described in this specification can be implemented in digital electronic circuitry, or in computer software, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language resource), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices: magnetic disks, e.g., internal hard disks or removable disks: magneto-optical disks: and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback: and input from the user can be received in any form, including acoustic, speech, or tactile input. In addition, a computer can interact with a user by sending resources to and receiving resources from a device that is used by the user; for example, by sending web pages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation.

Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

Each numerical value presented herein is contemplated to represent a minimum value or a maximum value in a range for a corresponding parameter. Accordingly, when added to the claims, the numerical value provides express support for claiming the range, which may lie above or below the numerical value, in accordance with the teachings herein. Every value between the minimum value and the maximum value within each numerical range presented herein (including in the charts shown in the figures), is contemplated and expressly supported herein, subject to the number of significant digits expressed in each particular range. Absent express inclusion in the claims, each numerical value presented herein is not to be considered limiting in any regard.

Unless expressly described elsewhere in this application, as used herein, when the term “substantially” or “about” is before a quantitative value, the present disclosure also includes the specific quantitative value itself, as well as, in various cases, a ±1%, ±2%, ±5%, and/or ±10% variation from the nominal value unless otherwise indicated or inferred.

Having described herein illustrative embodiments, persons of ordinary skill in the art will appreciate various other features and advantages of the invention apart from those specifically described above. It should therefore be understood that the foregoing is only illustrative of the principles of the invention, and that various modifications and additions, as well as all combinations and permutations of the various elements and components recited herein, can be made by those skilled in the art without departing from the spirit and scope of the invention. Accordingly, the appended claims shall not be limited by the particular features that have been shown and described, but shall be construed also to cover any obvious modifications and equivalents thereof.

What is claimed is:

1. A method of operating a moveable architectural element, the method comprising:
receiving an indicator of a detection event; and
in response thereto, performing a movement of the moveable architectural element from a first position to a second position, wherein the second position is selected to reduce an interference of the moveable architectural element with an alleviation system configured to alleviate the detection event.

2. The method of claim 1, wherein the receiving step comprises receiving the indicator of the detection event from a detector.

3. The method of claim 2, wherein the detector comprises at least one of: a smoke detector, a heat sensor, and a CO detector.

4. The method of claim 1, wherein the detection event comprises at least one of: fire, carbon monoxide, and smoke.

5. The method of claim 1, wherein the second position is selected based on a distance of the moveable architectural element from the alleviation system.

6. The method of claim 1, wherein the second position is selected based on an orientation of the moveable architectural element with respect to the alleviation system.

7. The method of claim 1, wherein the second position is selected based on both a distance of the moveable architectural element from the alleviation system and an orientation of the moveable architectural element with respect to the alleviation system.

8. The method of claim 1, wherein the alleviation system comprises a sprinkler.

9. The method of claim 1, further comprising, prior to receiving the indicator of the detection event, receiving a selection of the second position.

10. The method of claim 9, wherein the received selection of the second position is based on a configuration of the alleviation system.

11. The method of claim 1, further comprising, after receiving the indicator of the detection event, determining the second position.

12. The method of claim 1, further comprising, based on receiving an indicator of a loss of power, performing the movement of the moveable architectural element from the first position to the second position.

13. The method of claim 1, wherein the interference of the moveable architectural element with the alleviation system is based on at least one of: an amount of time for the alleviation system to alleviate the detection event and an amount of an alleviation substance provided by the alleviation system to alleviate the detection event.

14. The method of claim 13, wherein the alleviation substance comprises water.

15. The method of claim 1, wherein the second position is selected to eliminate the interference of the moveable architectural element with the alleviation system configured to alleviate the detection event.

16. A system for operating a moveable architectural element, the system comprising:
a motor adapted to move the moveable architectural element;
at least one of a controller and a data processing apparatus, programmed to perform operations comprising:
receiving an indicator of a detection event; and
in response thereto, performing a movement of the moveable architectural element from a first position to a second position using the motor, wherein the second position is selected to reduce an interference of the moveable architectural element with an alleviation system configured to alleviate the detection event.
